(19) United States
(12) Patent Application Publication
(10) Pub. No.: US 2026/0334587 A1
(43) Pub. Date: Oct. 29, 2026

(54) AEROSOL GENERATING DEVICE

(71) Applicant: KT & G CORPORATION, Daejeon (KR)

(72) Inventors: Yong Hwan KIM, Anyang-si (KR); Young Bum KWON, Yongin-si (KR); Dong Sung KIM, Seoul (KR); Hwi Kyeong AN, Seoul (KR)

(73) Assignee: KT & G CORPORATION, Daejeon (KR)

(21) Appl. No.: 19/118,431

(22) PCT Filed: Aug. 30, 2024
(86) PCT No.: PCT/KR2024/013024

§ 371 Date: Apr. 4, 2025

(30) Foreign Application Priority Data
Sep. 4, 2023 (KR) 10-2023-0117237
Nov. 13, 2023 (KR) 10-2023-0156315

(51) Int. Cl. A24F 40/57; A24F 40/53; A24F 40/60; H05B 1/02

(52) U.S. Cl. CPC A24F 40/57; A24F 40/53; A24F 40/60; H05B 1/0252

(57) ABSTRACT

An aerosol generating device, according to an embodiment, includes a power source; a heater that heats an aerosol generating article based on power supplied from the power source; a temperature sensor that senses a temperature of the heater; and a controller that controls the power supplied to the heater based on a temperature profile including a preheating section and a smoking section, wherein the controller controls the power supplied to the heater in the preheating section based on a first target temperature; a second target temperature lower than the first target temperature; a third target temperature lower than the first target temperature and higher than the second target temperature; and a fourth target temperature lower than the third target temperature and higher than the second target temperature.

### TECHNICAL FIELD

The present disclosure relates to an aerosol generating device.

### BACKGROUND ART

In recent years, there has been an increasing demand for alternative methods to overcome the disadvantages of conventional cigarettes. For example, there is an increasing demand for a method of generating aerosols by heating an aerosol generating material, rather than a method of generating aerosols by burning a cigarette. Accordingly, research on heated cigarettes or heated aerosol generating devices have been actively conducted.

### DISCLOSURE OF INVENTION

### Technical Problem

Various embodiments of the present disclosure relate to an aerosol generating device that changes a target temperature based on a time point when the target temperature is reached during preheating and changes the temperature based on the number of puffs in a smoking section after the preheating is completed.

### Solution to Problem

An aerosol generating device according to an embodiment includes: a power source; a heater that heats an aerosol generating article based on power supplied from the power source; a temperature sensor that senses a temperature of the heater; and a controller that controls the power supplied to the heater based on a temperature profile including a preheating section and a smoking section, wherein the controller controls the power supplied to the heater in the preheating section based on: a first target temperature; a second target temperature lower than the first target temperature; a third target temperature lower than the first target temperature and higher than the second target temperature; and a fourth target temperature lower than the third target temperature and higher than the second target temperature.

The preheating section includes a first section, a second section after the first section, a third section after the second section, and a fourth section after the third section, and the controller controls the power supplied to the heater, in the first section, such that the temperature of the heater reaches the first target temperature from a time point when a heating operation of the heater is initiated, controls the power supplied to the heater, in the second section, such that the temperature of the heater reaches the second target temperature from a first time point when the temperature of the heater reaches the first target temperature, controls the power supplied to the heater, in the third section, such that the temperature of the heater reaches the third target temperature from a second time point when the temperature of the heater reaches the second target temperature, and controls the power supplied to the heater, in the fourth section, such that the temperature of the heater reaches the fourth target temperature.

The third section includes a third-1 section and a third-2 section following the third-1 section, and the controller controls the power supplied to the heater, in the third-1 section, such that the temperature of the heater reaches the third target temperature from a second time point when the temperature of the heater reaches the second target temperature, and controls the power supplied to the heater, in the third-2 section, such that the temperature of the heater is maintained at the third target temperature.

The fourth section includes a fourth-1 section and a fourth-2 section following the fourth-1 section, and the controller controls the power supplied to the heater, in the fourth-1 section, such that the temperature of the heater reaches the fourth target temperature from the third target temperature, and controls the power supplied to the heater, in the fourth-2 section, such that the temperature of the heater is maintained at the fourth target temperature.

The controller cuts off power supplied to the heater from the first time point to the second time point.

The controller sets the length of the third section based on the length of the first section.

The controller sets the length of the third section based on the length of the second section.

The controller sets a value of the third target temperature based on the length of the first section.

The controller sets the length of the third section in proportion to the length of the first section.

The controller sets a value of the third target temperature in inverse proportion to the length of the first section.

The aerosol generating device according to an embodiment further includes a puff sensor that senses a puff of a user and output a signal corresponding to the puff, wherein the controller controls, based on the number of puffs counted through the puff sensor, power supplied to the heater in the smoking section.

The controller controls the power supplied to the heater such that the temperature of the heater reaches a fifth target temperature higher than the fourth target temperature when the counted number of puffs is K, controls the power supplied to the heater such that the temperature of the heater reaches a sixth target temperature higher than the fifth target temperature when the counted number of puffs is L greater than the K, and controls the power supplied to the heater such that the temperature of the heater reaches a seventh target temperature lower than the fourth target temperature when the counted number of puffs is M greater than the K.

The aerosol generating device according to an embodiment further includes an output unit that outputs information on a state of the aerosol generating device, wherein the controller controls the output unit such that the output unit outputs a notice to terminate the aerosol generating device, when the counted number of puffs is the M.

When the counted number of puffs is M+1, the controller controls the power supplied to the heater to be cut off, and controls the output unit such that the output unit outputs the termination of the aerosol generating device.

The output unit communicates information about a state of the aerosol generating device to a user using at least one of tactile, visual, or auditory means.

### Advantageous Effects of Invention

The aerosol generating device according to an embodiment performs temperature control in an “N” shape, thereby allowing the heater to be stably preheated to a target temperature without carbonization of the aerosol generating substrate. Accordingly, the aerosol generating device of the present disclosure may provide a user with rich vapor and taste in the smoking section.

In addition, while the temperature of the heater is controlled in the smoking section, using a continuous ascent control method by which the temperature of the heater is continuously increased in the smoking section, the target temperature of the heater may be lowered when approaching the end of smoking to prevent overheating of the aerosol generating device in relation to “continuous smoking”.

### BRIEF DESCRIPTION OF DRAWINGS

FIG. 1 is a diagram of an aerosol generating system according to an embodiment.

FIG. 2 is a diagram of an aerosol generating system according to another embodiment.

FIGS. 3 to 5 are diagrams of different types of cigarettes according to an embodiment.

FIG. 6 is a block diagram of an aerosol generating device according to an embodiment of the present disclosure.

FIG. 7 is a diagram illustrating a temperature profile of an aerosol generating device according to an embodiment.

FIG. 8 is a diagram illustrating a temperature profile in a preheating section according to an embodiment of the present disclosure.

FIG. 9 is a diagram illustrating a method of adjusting the temperature profile in the preheating section by the aerosol generating device according to an embodiment of the present disclosure.

FIG. 10 is a diagram illustrating a temperature profile in a smoking section according to an embodiment of the present disclosure.

### BEST MODE FOR CARRYING OUT THE INVENTION

### Mode for the Invention

The terms used in embodiments are selected from general terms currently widely used as much as possible in consideration of the functions in the present disclosure but may vary depending on the intention of a person skilled in the art, precedents, and the emergence of new technologies. In addition, in certain cases, there are terms arbitrarily selected by the applicant, and in such cases, the meanings thereof will be described in detail in the description of the disclosure. Therefore, the terms used in the present disclosure should be defined based on the meaning of the terms and the overall content of the present disclosure, rather than the mere names of the terms.

Throughout the specification, when a part “includes” an element, unless otherwise specified, the part may further include other elements, instead of excluding the other elements. In addition, the terms, such as “unit” or “module”, described in the specification refer to a unit for processing at least one function or operation, which may be implemented in hardware or software or may be implemented in a combination of hardware and software.

As used herein, when an expression, such as “at least one of”, precedes an array of components, it modifies the entire array of components, rather than each individual element. For example, an expression “at least one of a, b, and c” shall be construed to include a, b, c, or a and b, a and c, b and c, or a and b and c.

In an embodiment, the aerosol generating device may be a device that electrically heats a cigarette accommodated in the internal space to generate aerosols.

The aerosol generating device may include a heater. In an embodiment, the heater may be an electrically resistive heater. For example, the heater may include an electrically conductive track, and the heather may be heated when current flows through the electrically conductive track.

The heater may include a tubular heating element, a plate-shaped heating element, a needle-shaped heating element or a rod-shaped heating element and may heat the inside or the outside of the cigarette depending on the shape of the heating element.

The cigarette may include a tobacco rod and a filter rod. The tobacco rod may be made of a sheet, may be made of strands, and may be made of shredded tobacco sheets. In addition, the tobacco rod may be surrounded by a thermally conductive material. For example, the thermally conductive material may be, but is not limited to, metal foil, such as aluminum foil.

The filter rod may be a cellulose acetate filter. The filter rod may consist of at least one or more segments. For example, the filter rod may include a first segment for cooling aerosol and a second segment for filtering certain components contained within the aerosol.

In another embodiment, the aerosol generating device may be a device for generating aerosols using a cartridge including an aerosol generating material.

The aerosol generating device may include the cartridge including the aerosol generating material and a body supporting the cartridge. The cartridge may be removably coupled with the body, but is not limited thereto. The cartridge may be integrally formed or assembled with the body and may be fixed thereto so as not to be removed by a user. The cartridge may be mounted to the body with the aerosol generating material contained therein. However, the present disclosure is not limited thereto, and the aerosol-generating material may be injected into the cartridge in a state where the cartridge is coupled to the body.

The cartridge may include the aerosol generating material having any one of a variety of states, such as a liquid state, a solid state, a gaseous state, or a gel state. The aerosol generating material may include a liquid composition. For example, the liquid composition may be a liquid including a tobacco-containing material including volatile tobacco flavoring components or may be a liquid including a non-tobacco material.

The cartridge may convert the phase of the aerosol generating material inside the cartridge into a gas phase to perform the function of generating aerosols by operating with an electrical signal or a wireless signal transmitted from the body. The aerosol may refer to a gas which is a mixture of vaporized particles and air generated from the aerosol generating material.

In the other embodiment, the aerosol generating device may heat a liquid composition to generate aerosols, and the generated aerosol may be delivered to the user through the cigarette. That is, the aerosol generated from the liquid composition may travel along an airflow path of the aerosol generating device, wherein the airflow path may be configured to allow the aerosol to pass through the cigarette and be delivered to the user.

In the other embodiment, the aerosol generating device may be a device that generates aerosols from the aerosol generating material using an ultrasonic vibration method. In this case, the ultrasonic vibration method may refer to a method by which aerosol is generated by atomizing the aerosol generating material with ultrasonic vibration generated by a vibrator.

The aerosol generating device may include the vibrator and may generate a short period of vibration through the vibrator to atomize the aerosol generating material. The vibration generated by the vibrator may be ultrasonic vibration, and a frequency band of the ultrasonic vibration may be, but is not limited to, a frequency band of about 100 kHz to about 3.5 MHz.

The aerosol generating device may further include a wick for absorbing the aerosol generating material. For example, the wick may be arranged to surround at least a portion of the vibrator or may be arranged to contact at least a portion of the vibrator. As a voltage (e.g., an alternating voltage) is applied to the vibrator, heat and/or ultrasonic vibration may be generated from the vibrator and the heat and/or ultrasound vibration generated by the vibrator may be transferred to the aerosol generating material absorbed by the wick. The aerosol generating material absorbed by the wick may be converted into a phase of gas by heat and/or ultrasonic vibration transmitted from the vibrator, resulting in the generation of aerosol.

For example, the viscosity of the aerosol generating material absorbed by the wick may be reduced by heat generated from the vibrator, and the aerosol generating material having the reduced viscosity may be finely particulated by ultrasonic vibration generated from the vibrator, thereby generating aerosols.

In the other embodiment, the aerosol generating device may be a device that generates aerosols by heating an aerosol generating article accommodated in the aerosol generating device using an induction heating method.

The aerosol generating device may include a susceptor and a coil. In an embodiment, the coil is capable of applying a magnetic field to the susceptor. As power is supplied to the coil from the aerosol generating device, the magnetic field may be formed inside the coil. In an embodiment, the susceptor may be a magnetic substance that generates heat by an external magnetic field. As the susceptor is located inside the coil and the magnetic field is applied, the aerosol generating article may be heated by generating heat. In addition, optionally, the susceptor may be located in the aerosol generating article.

In the other embodiment, the aerosol generating device may further include a cradle.

The aerosol generating device may constitute a system with a separate cradle. For example, the cradle may charge a battery of the aerosol generating device. Alternatively, the heater may be heated while the cradle and the aerosol generating device are coupled to each other.

Hereinafter, embodiments of the present disclosure will be described in detail with reference to the accompanying drawings so that a person skilled in the art can easily implement the same. The present disclosure may be implemented in a form that can be implemented in aerosol generating devices of various embodiments described above or may be implemented in various different forms, and is not limited to embodiments described herein.

Hereinafter, embodiments of the present disclosure are described in detail with reference to the drawings.

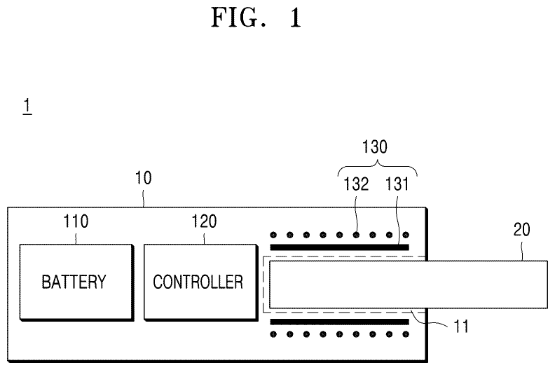

FIG. 1 is a diagram of an aerosol generating system according to an embodiment.

Referring to FIG. 1, an aerosol generating system 1 may include an aerosol generating device 10 and an aerosol generating article 20. Hereinafter, the aerosol generating article 20 may be referred to as a cigarette or a stick.

The aerosol generating device 10 may include a cavity 11, which is an insertion space (or a receiving space) where the aerosol generating article 20 is inserted, and may generate an aerosol by heating the aerosol generating article 20 inserted into the cavity 11. The aerosol generating article 20 may include an aerosol generating material as a type of an aerosol generating substrate.

The aerosol generating device 10 may include a battery 110, a controller 120, and a heating unit 130. The heating unit 130 may be referred to as a heater assembly (or heater). The heating unit 130 may correspond to a heater assembly for heating the aerosol generating article 20 by using various heating methods, such as a resistance heating method, an induction heating method, a dielectric heating method, or an ultrasonic method. When the heating unit 130 heats the aerosol generating article 20 using an induction heating method, the heating unit 130 may include a susceptor 131 and an induction coil 132. Hereinafter, an embodiment in which the heating unit 130 heats the aerosol generating article 20 using the induction heating method is described but the embodiment is not limited thereto.

Meanwhile, the internal structure and arrangement of the aerosol generating device 10 are not limited to those shown in FIG. 1. It may be understood by a person skilled in the art that, according to the design of the aerosol generating device 10, some of the hardware configurations shown in FIG. 1 may be omitted or new configurations may be further added, and each hardware configuration may be implemented in various arrangements.

The aerosol generating device 10 may generate an aerosol by heating the aerosol generating article 20 accommodated in the aerosol generating device 10 using the induction heating method. The induction heating method may refer to a method of heating a magnetic substance by applying an alternating magnetic field whose direction changes periodically to the magnetic substance that is heated by an external magnetic field.

When the alternating magnetic field is applied to the magnetic substance, energy loss due to eddy current loss and hysteresis loss may occur in the magnetic substance and the lost energy may be released from the magnetic substance as thermal energy. The greater the amplitude or frequency of the alternating magnetic field applied to the magnetic substance, the more thermal energy may be released from the magnetic substance. The aerosol generating device 10 may emit thermal energy from the magnetic substance by applying the alternating magnetic field to the magnetic substance and may transfer the thermal energy emitted from the magnetic substance to the aerosol generating article 20.

The magnetic substance that generates heat by the external magnetic field may include a susceptor material. The susceptor 131 may be provided in the aerosol generating device 10 in the shape of a piece, a thin piece, a strip, or the like. For example, at least a portion of the susceptor 131 arranged inside the aerosol generating device 10 may include the susceptor material.

At least a portion of the susceptor material may be formed of a ferromagnetic substance. For example, the susceptor material may include metal or carbon. The susceptor material may include at least one of ferrite, a ferromagnetic alloy, stainless steel, and aluminum (Al). In addition, the susceptor material may include at least one of graphite, molybdenum, silicon carbide, niobium, a nickel alloy, a metal film, a ceramic, such as zirconia, a transition metal, such as nickel (Ni) or cobalt (Co), or a metalloid, such as boron (B) or phosphorus (P).

The susceptor 131 may be tubular or cylindrical and may be arranged outside the susceptor 131 to surround the cavity 11 into which the aerosol generating article 20 is inserted. Accordingly, when the aerosol generating article 20 is inserted into the cavity 11 of the aerosol generating device 10, the susceptor 131 may be arranged outside the aerosol generating article 20 to surround the aerosol generating article 20. Accordingly, the temperature of the aerosol generating material in the aerosol generating article 20 may be increased by the heat transferred from the susceptor 131.

The induction coil 132 may apply the alternating magnetic field to the susceptor 131. When power is supplied from the aerosol generating device 10 to the induction coil 132, a magnetic field may be formed inside the induction coil 132. When an alternating current is applied to the induction coil 132, the direction of the magnetic field formed inside the induction coil 132 may be continuously changed. When the susceptor 131 is located inside the induction coil 132 and is exposed to the alternating magnetic field whose direction changes periodically, the susceptor 131 may generate heat and the aerosol generating article 20 accommodated in the cavity 11 may be heated.

The induction coil 132 may be wound along the outer surface of the susceptor 131. In addition, the induction coil 132 may be wound along the inner surface of the outer housing of the aerosol generating device 10. The susceptor 131 may be located in an inner space formed by winding the induction coil 132. The alternating magnetic field generated by the induction coil 132 may be applied to the susceptor 131 when power is supplied to the induction coil 132.

The induction coil 132 may extend in the longitudinal direction of the aerosol generating device 10. The induction coil 132 may extend to a suitable length in the longitudinal direction. For example, the induction coil 132 may extend to a length corresponding to the length of the susceptor 131 or may extend to a length longer or shorter than the length of the susceptor 131.

The induction coil 132 may be arranged at a position suitable for applying the alternating magnetic field to the susceptor 131. The size, length, or arrangement of the induction coil 132 may vary the efficiency with which the alternating magnetic field of the induction coil 132 is applied to the susceptor 131.

When the amplitude or frequency of the alternating magnetic field formed by the induction coil 132 is changed, the degree of heating the susceptor 131 (e.g., the temperature of the susceptor 131) may be changed, thereby changing the degree to which the aerosol generating article 20 is heated by the susceptor 131. Since the amplitude or frequency of the magnetic field by the induction coil 132 can be changed by the power applied to the induction coil 132, the aerosol generating device 10 may control the heating of the aerosol generating article 20 by adjusting the power applied to the induction coil 132. For example, the aerosol generating device 10 may control the amplitude and frequency of the alternating current applied to the induction coil 132.

As an example, the induction coil 132 may be implemented as a solenoid. The induction coil 132 may include the solenoid wound along the inner surface of the outer housing of the aerosol generating device 10, and the susceptor 131 and the aerosol generating article 20 may be located in the inner space of the solenoid. The material of the conductive wire constituting the solenoid may be copper (Cu). However, the material is not limited thereto, and any one of silver (Ag), gold (Au), aluminum (Al), tungsten (W), zinc (Zn), and nickel (Ni), or an alloy including at least one thereof may be used as the material of the conductive wire constituting the solenoid.

The battery 110 may supply power to the induction coil 132. The battery 110 may include, but is not limited to, a lithium iron phosphate (LiFePO₄) battery. For example, the battery 110 may be a lithium cobalt oxide (LiCoO₂) battery, a lithium titanate battery, a lithium polymer (LiPoly) battery, or the like.

The controller 120 may control power supplied to the induction coil 132 and may also control overall functions and operations of the aerosol generating device 1. The controller 120 may control the power supplied from the battery 110 to the induction coil 132 to be adjusted. For example, the controller 120 may control the power supplied to the induction coil 132 such that the susceptor 131 reaches a target temperature on a temperature profile or maintains the target temperature.

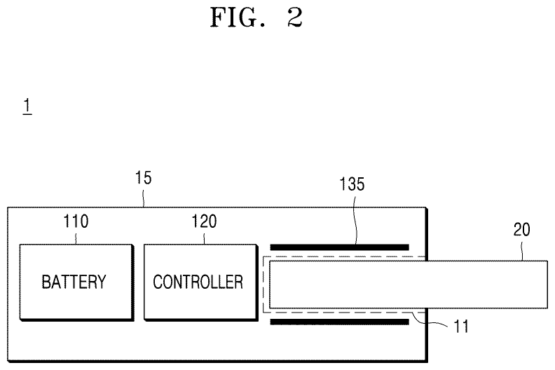

Although not shown in FIGS. 1 and 2, the aerosol generating device 10 may also constitute a system with a separate cradle. For example, the cradle may be used to charge the battery 110 of the aerosol generating device 10. Alternatively, the induction coil 132 may be heated while the cradle and the aerosol generating device 10 are coupled to each other.

FIG. 2 is a diagram of an aerosol generating system according to another embodiment.

Compared to the aerosol generating device 10 of FIG. 1, an aerosol generating device 15 of FIG. 2 is provided with a heating unit 135 using a different heating method.

The heating unit 135 may include a heater assembly using an external heating method for heating the outside of the aerosol generating article 20 by heating the heating unit 135 with power supplied from the battery 110 when the aerosol generating article 20 is inserted into the aerosol generating device 15. Therefore, the heating unit 135 may be implemented in a tubular or cylindrical structure.

The heating unit 135 may be implemented as an electrically resistive heater. For example, the heating unit 135 may include an electrically conductive track and the heating unit 135 may be heated according to a current flowing through the electrically conductive track.

That is, FIGS. 1 and 2 are diagrams for describing examples of aerosol generating devices including the heater assembly using the external heating method for heating the outside of the aerosol generating article (i.e., a cigarette). The embodiment to be described below may be easily modified and implemented from the aerosol generating devices 10 and 15 in FIGS. 1 and 2. On the other hand, the embodiment may also be implemented as the aerosol generating device using the external heating method other than the method described with reference to FIGS. 1 and 2.

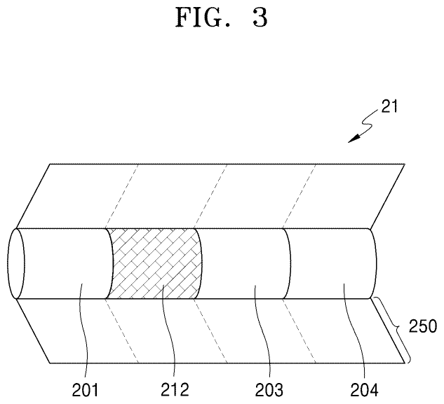

FIGS. 3 to 5 are diagrams of different types of cigarettes according to an embodiment.

Referring to FIGS. 3 to 5, a cigarette 21, 22, or 23 may correspond to the aerosol generating article 20 in FIGS. 1 and 2. The cigarette 21, 22, or 23 may be divided into a first portion 201, a second portion 212, 222, or 232, a third portion 203, and a fourth portion 204. The first portion 201, the second portion 212, 222, or 232, the third portion 203, and the fourth portion 204 may each include an aerosol generating element, a tobacco medium element, a cooling element, and a filter element. Specifically, the first portion 201 may include an aerosol generating material, the second portion 212, 222, or 232 may include a tobacco material and a humectant, the third portion 203 may include means for cooling the airflow passing through the first portions 201 and second portions 212, 222, or 232, and the fourth portion 204 may include a filter material.

The first portion 201, the second portion 212, 222, or 232, the third portion 203, and the fourth portion 204 may be arranged in sequence based on the longitudinal direction of the cigarette 21, 22, or 23. The longitudinal direction may be a direction in which the length of the cigarette 21, 22, or 23 extends and may be a direction from the first portion 201 to the fourth portion 204. As such, aerosol generated from at least one of the first portion 201 and the second portion 212, 222, or 232 may pass through the first portion 201 to the fourth portion 204 in sequence to form the airflow, such that a user may inhale the aerosol from the fourth portion 204.

The first portion 201 may include the aerosol generating element. As the aerosol generating element, the first portion 201 may include other additives, such as a flavoring agent, a wetting agent, and/or an organic acid, and may include flavorings, such as menthol or a humectant. The aerosol generating element may include at least one of, for example, glycerin, propylene glycol, ethylene glycol, dipropylene glycol, diethylene glycol, triethylene glycol, tetraethylene glycol, and oleyl alcohol.

The first portion 201 may include a compressed sheet, and the aerosol generating element may be included in the first portion 201 while being impregnated in the compressed sheet. The other additives, such as a flavoring agent, a wetting agent and/or an organic acid, and the flavorings may also be included in the first portion 201 while being absorbed into the compressed sheet. The compressed sheet may be a sheet formed of a polymer material. For example, the polymer material may include at least one of paper, cellulose acetate, lyocell, and polylactic acid (PLA). For example, the compressed sheet may be a paper sheet which does not generate an off-flavor due to heat even when heated to a high temperature. However, the present disclosure is not limited thereto.

The first portion 201 may extend from the end of the cigarette 21, 22, or 23 to a point of about 7 mm to about 20 mm, and the second portion 212, 222, or 232 may extend from a point where the first portion 201 ends to a point of about 7 mm to about 20 mm. However, the present disclosure is not necessarily limited to such a numerical range, and the length by which each of the first portion 201 and the second portion 212, 222, or 232 extends may be appropriately adjusted within a range that can be easily changed by a person skilled in the art.

The second portion 212, 222, or 232 may include the tobacco medium element. The cigarette type may be divided by which tobacco medium is included in the second portion 212, 222, or 232.

Specifically, referring to FIG. 3, the second portion 212 provided in the cigarette 21 may include the filter material impregnated with nicotine liquid. The nicotine liquid may correspond to a nicotine solution including a tobacco-containing material including a volatile tobacco flavoring component or may correspond to a solution to which nicotine salt is added. The filter material may be a fiber bundle in which cellulose acetate fiber strands are bundled or may be a wound paper sheet. In other words, the cigarette 21 corresponds to a cigarette type including a tobacco medium in which the nicotine liquid is impregnated in the filter material in the second portion 212.

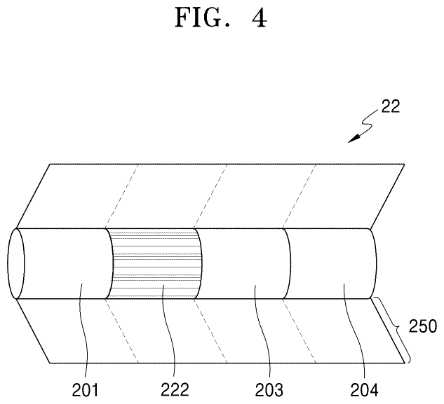

Referring to FIG. 4, the second portion 222 included in the cigarette 22 may include a plurality of tobacco granules. The plurality of tobacco granules may be embedded in between the filter material. The filter material may be, for example, a fiber bundle in which cellulose acetate fiber strands are bundled or a wound paper sheet. The plurality of tobacco granules may be arranged in a uniformly dispersed form between the cellulose fibers or the plurality of tobacco granules may be uniformly dispersed inside the wound paper sheet. In other words, the cigarette 22 corresponds to a cigarette type including a tobacco medium of tobacco granules in the second portion 222.

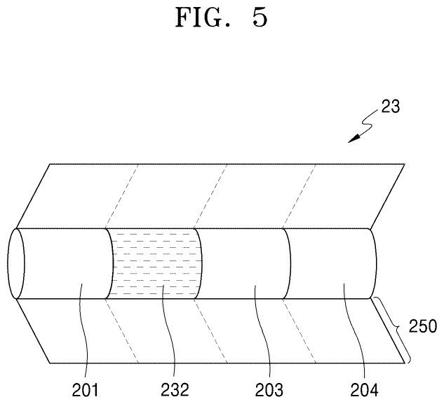

Referring to FIG. 5, the second portion 232 provided in the cigarette 23 may include cut tobacco, tobacco particles, or tobacco sheets. That is, the cigarette 23 corresponds to a cigarette type including a solid tobacco material, such as tobacco leaves, tobacco veins, puffed tobacco, cut tobacco, cut reconstituted tobacco, or reconstituted tobacco in the second portion 232.

The third portion 203 may include means for cooling the airflow passing through the first portion 201 and the second portion 212, 222, or 232. The third portion 203 may be made of a polymeric material or a biodegradable polymeric material and may have a cooling function. For example, the third portion 203 may be made of PLA fiber, but is not limited thereto. Alternatively, the third portion 203 may be produced as a cellulose acetate filter with a plurality of holes. However, the third portion 203 is not limited to the above-described examples and the material that performs the function of cooling aerosol may be included therein without limitation. For example, the third portion 203 may include a tube filter or a paper tube filter including a hollow.

The fourth portion 204 may include the filter material. For example, the fourth portion 204 may include a cellulose acetate filter. The shape of the fourth portion 204 is not limited. For example, the fourth portion 204 may be a cylindrical-type rod or a tubular-type rod including a hollow therein. The fourth portion 204 may be a recess-type rod. When the fourth portion 204 is composed of a plurality of segments, at least one of the plurality of segments may be fabricated into another shape.

The fourth portion 204 may be fabricated to generate flavor. As an example, the flavorings may be sprayed on the fourth portion 204, and a separate fiber to which the flavorings are applied may be inserted into the fourth portion 204.

The cigarette 21, 22, or 23 may include a wrapper 250 surrounding at least a portion of the first portion 201 to the fourth portion 204. In addition, the cigarette 21, 22, or 23 may include a wrapper 250 surrounding all of the first portion 201 to the fourth portion 204. The wrapper 250 may be located on the outermost edge of the cigarette 21, 22, or 23, and the wrapper 250 may include a single wrapper or a combination of a plurality of wrappers.

The wrapper 250 may include a thermally conductive material. For example, the thermally conductive material may be metal foil, such as Ag foil, Al foil, Cu foil, or the like. The thermally conductive material provided in the wrapper 250 may evenly disperse the heat transferred to the first portion 201 to the second portion 212, 222, or 232 to improve the thermal conductivity, thereby improving the taste of cigarettes. The thermally conductive material included in the wrapper 250 may also function as a susceptor.

The thermally conductive material of the wrapper 250 may be used as an electromagnetic inductor for cigarette sensing. The thermally conductive material of the wrapper 250 may change the inductance of cigarette sensing means. The aerosol generating device (10 in FIG. 1) may determine, based on the sensed inductance change, whether the cigarette 21, 22, or 23 is inserted into or extracted from the aerosol generating device 10.

Although three cigarette types shown in FIGS. 3 to 5 are illustrated in the embodiment, various cigarettes may be used in the aerosol generating system 1, in addition to the cigarette types including the tobacco medium elements described with reference to FIGS. 3 to 5. In addition, in the embodiment, the cigarette 21, 22, or 23 is described as a structure that can be divided into four portions but is not limited thereto, and the cigarette may also be implemented as various cigarette structures including a tobacco medium element.

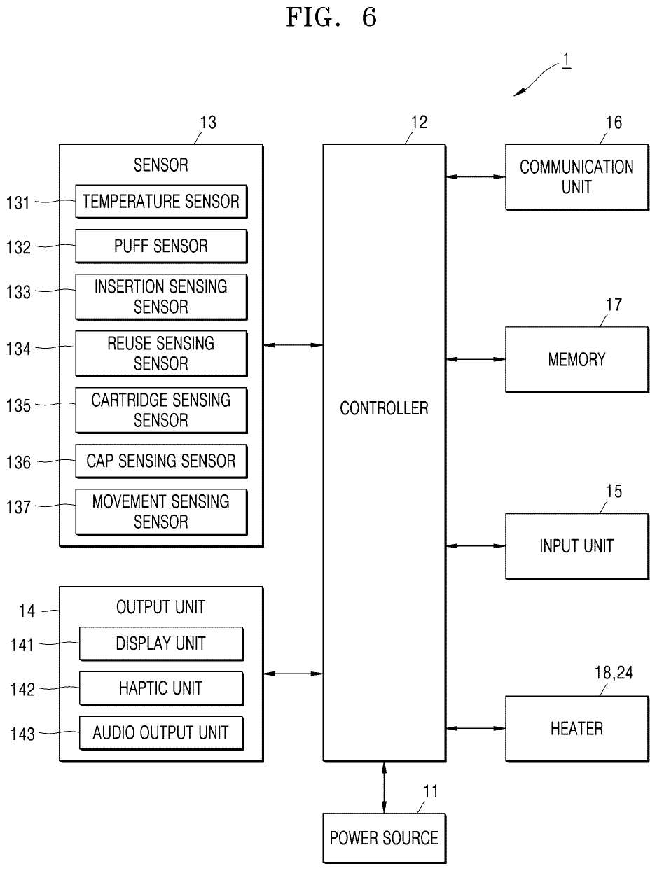

FIG. 6 is a block diagram of an aerosol generating device 1 according to an embodiment of the present disclosure.

The aerosol generating device 1 may include a power source 11, a controller 12, a sensor 13, an output unit 14, an input unit 15, a communication unit 16, memory 17, and at least one heater 18 and 24. However, the internal structure of the aerosol generating device 1 is not limited to that shown in FIG. 1. That is, a person skilled in the art may understand that, according to the design of the aerosol generating device 1, some of the configurations shown in FIG. 1 may be omitted or new configurations may be further added.

The sensor 13 may sense a state of the aerosol generating device 1 or a state around the aerosol generating device 1 and may transfer the sensed information to the controller 12. Based on the sensed information, the controller 12 may control the aerosol generating device 1 to perform various functions, such as controlling the operation of the cartridge heater 24 and/or the heater 18, limiting smoking, determining whether to insert a stick S and/or a cartridge 19, displaying a notification, and the like.

The sensor 13 may include at least one of a temperature sensor 131, a puff sensor 132, an insertion sensing sensor 133, a reuse sensing sensor 134, a cartridge sensing sensor 135, a cap sensing sensor 136, and a movement sensing sensor 137.

The temperature sensor 131 may sense a temperature at which the cartridge heater 24 and/or the heater 18 is heated. The aerosol generating device 1 may include a separate temperature sensor that senses the temperature of the cartridge heater 24 and/or the heater 18, or the cartridge heater 24 and/or the heater 18 itself may function as the temperature sensor.

The temperature sensor 131 may output a signal corresponding to the temperature of the cartridge heater 24 and/or the heater 18. For example, the temperature sensor 131 may include a resistance element whose resistance value changes in response to a temperature change of the cartridge heater 24 and/or the heater 18. It may be implemented by a thermistor, which is a device using the property of its resistance changing depending on the temperature. The temperature sensor 131 may output a signal corresponding to the resistance value of the resistive element as a signal corresponding to the temperature of the cartridge heater 24 and/or the heater 18. For example, the temperature sensor 131 may be configured as a sensor that detects the resistance value of the cartridge heater 24 and/or the heater 18. The temperature sensor 131 may output a signal corresponding to the resistance value of the cartridge heater 24 and/or the heater 18 as a signal corresponding to the temperature of the cartridge heater 24 and/or the heater 18.

The temperature sensor 131 may be arranged around the power source 11 to monitor the temperature of the power source 11. The temperature sensor 131 may be arranged adjacent to the power source 11. For example, the temperature sensor 131 may be attached to one surface of a battery that is the power source 11. For example, the temperature sensor 131 may be mounted on one surface of a printed circuit board.

The temperature sensor 131 may be arranged inside a body 10 to sense the internal temperature of the body 10.

The puff sensor 132 may sense the user's puff based on various physical changes in the airflow path. The puff sensor 132 may sense the user's puff based on any one of a temperature change, a flow change, a voltage change, and a pressure change. The puff sensor 132 may output a signal corresponding to the puff. For example, the puff sensor 132 may include a pressure sensor. The puff sensor 132 may output a signal corresponding to the internal pressure of the aerosol generating device 1. The internal pressure of the aerosol generating device 1 may correspond to the pressure of the airflow path through which the gas flows. The puff sensor 132 may be arranged corresponding to the airflow path through which the gas flows in the aerosol generating device 1.

The insertion sensing sensor 133 may sense insertion and/or removal of the stick S. The insertion sensing sensor 133 may sense a signal change as the stick S is inserted and/or removed. The insertion sensing sensor 133 may be arranged around the insertion space. The insertion sensing sensor 133 may sense insertion and/or removal of the stick S according to a change in dielectric constant inside the insertion space. For example, the insertion sensing sensor 133 may include an inductive sensor and/or a capacitance sensor.

The inductive sensor may include at least one coil. The coil of the inductive sensor may be arranged adjacent to the insertion space. For example, when the magnetic field changes around the coil through which current flows, the characteristics of the current flowing through the coil may change according to Faraday's law. The characteristics of the current flowing through the coil may include a frequency, a current value, a voltage value, an inductance value, and an impedance value of the alternating current.

The inductive sensor may output a signal corresponding to the characteristics of the current flowing through the coil. For example, the inductive sensor may output a signal corresponding to the inductance value of the coil.

The capacitance sensor may include a conductor. The conductor of the capacitance sensor may be arranged adjacent to the insertion space. The capacitance sensor may output a signal corresponding to the electromagnetic characteristics of the surroundings, e.g., the electrostatic capacitance around the conductor. For example, when the stick S including a wrapper of a metal material is inserted into the insertion space, the electromagnetic characteristics around the conductor may be changed by the wrapper of the stick S.

The reuse sensing sensor 134 may sense whether the stick S is reused. The reuse sensing sensor 134 may include a color sensor. The color sensor may sense the color of the stick S. The color sensor may sense the color of a portion of the wrapper that wraps around the exterior of the stick S. The color sensor may detect, based on light reflected from an object, a value for optical characteristics corresponding to a color of the object. For example, the optical characteristics may include a wavelength of light. The color sensor may be implemented as a single configuration with a proximity sensor or may be implemented as a separate configuration from the proximity sensor.

At least a portion of the wrapper constituting the stick S may be changed in color by the aerosol. In a case where the stick S is inserted into the insertion space, the reuse sensing sensor 134 may be arranged corresponding to a position where at least a portion of the wrapper is changed in color by the aerosol. For example, before the stick S is used by the user, the color of at least a portion of the wrapper may be a first color. As at least a portion of the wrapper is wetted by the aerosol while the aerosol generated by the aerosol generating device 1 passes through the stick S, the color of at least a portion of the wrapper may be changed to s second color. Meanwhile, the color of at least a portion of the wrapper may be changed from the first color to the second color and then maintained at the second color.

The cartridge sensing sensor 135 may sense the mounting and/or removal of the cartridge 19. The cartridge sensing sensor 135 may be implemented by an inductance-based sensor, a capacitance-type sensor, a resistance sensor, and a Hall sensor using the Hall effect.

The cap sensing sensor 136 may sense mounting and/or removal of a cap. When the cap is separated from the body 10, a portion of the body 10 and the cartridge 19 covered by the cap may be exposed to the outside. The cap sensing sensor 136 may be implemented by a contact sensor, a Hall sensor, an optical sensor, or the like.

The movement sensing sensor 137 may sense movement of the aerosol generating device. The movement sensing sensor 137 may be implemented as at least one of an acceleration sensor and a gyro sensor.

In addition to the sensors 131 to 137 described above, the sensor 13 may further include at least one of a humidity sensor, a barometric pressure sensor, a magnetic sensor, a position sensor (GPS), and a proximity sensor. Since the function of each of the sensors can be intuitively inferred by a person skilled in the art from its name, the detailed description thereof may be omitted.

The output unit 14 may output information about a state of the aerosol generating device 1 and provide the information to the user. The output unit 14 may include, but is not limited to, at least one of a display unit 141, a haptic unit 142, and an audio output unit 143. When the display and the touchpad form a layered structure to form a touchscreen, the display unit 141 may be used as an input device in addition to an output device.

The display unit 141 may visually provide information about the aerosol generating device 1 to the user. For example, the information about the aerosol generating device 1 may refer to various information, such as a charging/discharging state of the power source 11 of the aerosol generating device 1, a preheating state of the heater 18, an insertion/removal state of the stick S and/or the cartridge 19, a mounting/removal state of the cap, or a state (e.g., detecting the abnormal article) in which the use of the aerosol generating device 1 is restricted, wherein the display unit 141 may output the information to the outside. For example, the display unit 141 may be in the form of an LED light emitting element. For example, the display unit 141 may include a liquid crystal display panel (LCD), an organic light-emitting display panel (OLED), or the like.

The haptic unit 142 may convert an electrical signal into a mechanical stimulus or an electrical stimulus to tactilely provide information about the aerosol generating device 1 to the user. For example, the haptic unit 142 may generate vibrations corresponding to completion of initial preheating when initial power is supplied to the cartridge heater 24 and/or the heater 18 for a set time. The haptic unit 142 may include a vibration motor, a piezoelectric element, or an electrical stimulation device.

The audio output unit 143 may audibly provide information about the aerosol generating device 1 to the user. For example, the audio output unit 143 may convert an electrical signal into an acoustic signal and output the acoustic signal to the outside.

The power source 11 may supply power used to operate the aerosol generating device 1. The power source 11 may supply power to heat the cartridge heater 24 and/or the heater 18. In addition, the power source 11 may supply power necessary for operations of the sensor 13, the output unit 14, the input unit 15, the communication unit 16, and the memory 17, which are other components included in the aerosol generating device 1. The power source 11 may include a rechargeable battery or a disposable battery. For example, the power source 11 may include, but is not limited to, a LiPoly battery.

Although not shown in FIG. 1, the aerosol generating device 1 may further include a power source protection circuit. The power source protection circuit may be electrically connected with the power source 11 and may include a switching element.

The power source protection circuit may cut off the electric path to the power source 11 according to a certain condition. For example, the power source protection circuit may cut off the electric path to the power source 11 when the voltage level of the power source 11 is greater than or equal to a first voltage corresponding to overcharge. For example, the power source protection circuit may cut off the electric path to the power source 11 when the voltage level of the power source 11 is less than a second voltage corresponding to over-discharge.

The heater 18 may receive power from the power source 11 to heat the aerosol generating material or the medium in the stick S. Although not shown in FIG. 1, the aerosol generating device 1 may further include a power conversion circuit (e.g., a DC/DC converter) that converts power of the power source 11 and supplies the power to the cartridge heater 24 and/or the heater 18. In addition, when the aerosol generating device 1 generates aerosols using the induction heating method, the aerosol generating device 1 may further include a DC/AC converter which converts a direct current power source of the power source 11 into an alternating current power source.

The controller 12, the sensor 13, the output unit 14, the input unit 15, the communication unit 16, and the memory 17 may receive power from the power source 11 to perform functions. Although not shown in FIG. 1, it may further include a power conversion circuit, e.g., a low dropout (LDO) circuit or a voltage regulator circuit, which converts and supplies the power of the power source 11 to the respective components. Although not shown in FIG. 1, a noise filter may be provided between the power source 11 and the heater 18. The noise filter may include a low pass filter. The low pass filter may include at least one inductor and a capacitor. The cutoff frequency of the low pass filter may correspond to the frequency of the high-frequency switching current applied from the power source 11 to the heater 18. The low pass filter may prevent a high-frequency noise component from being applied to the sensor 13, such as the insertion sensing sensor 133.

In an embodiment, the cartridge heater 24 and/or the heater 18 may be formed of any suitable electrically resistive material. For example, the suitable electrically resistive material may include a metal or a metal alloy including, but not limited to, titanium, zirconium, tantalum, platinum, nickel, cobalt, chromium, hafnium, niobium, molybdenum, tungsten, tin, gallium, manganese, iron, copper, stainless steel, nichrome, and the like. In addition, the heater 18 may be implemented as, but is not limited to, a metal wire, a metal plate on which an electrically conductive track is arranged, a ceramic heating element, or the like.

In another embodiment, the heater 18 may include a heater using the induction heating method. For example, the heater 18 may include a susceptor that generates heat through a magnetic field applied by the coil, thereby heating the aerosol generating material.

The input unit 15 may receive information input from the user or may output information to the user. For example, the input unit 15 may include a touch panel. The touch panel may include at least one touch sensor that senses touch. For example, the touch sensor may include, but is not limited to, a capacitive touch sensor, a resistive touch sensor, a surface acoustic wave touch sensor, an infrared touch sensor, and the like.

The display 141 and the touch panel may be implemented as one panel. For example, the touch panel may be inserted into the display 141 (on-cell type or in-cell type). For example, the touch panel may be added on to the display panel (add-on type).

The input unit 15 may include, but is not limited to, a button, a keypad, a dome switch, a jog wheel, a jog switch, and the like.

The memory 17 which is hardware for storing various types of data processed in the aerosol generating device 1 may store data to be processed and data processed in the controller 12. The memory 17 may include at least one type of storage medium selected from a flash memory type, a hard disk type, a multimedia card micro type, a card type memory (such as an SD or XD memory), random access memory (RAM), static random access memory (SRAM), read-only memory (ROM), electrically erasable programmable read-only storage (EEPROM), programmable read-only memory (PROM), magnetic memory, a magnetic disk, and an optical disc. The memory 17 may store data about an operation time of the aerosol generating device 1, a maximum number of puffs, a current number of puffs, at least one temperature profile, and a smoking pattern of the user.

The communication unit 16 may include at least one component for communication with another electronic device. For example, the communication unit 16 may include at least one of a short-range wireless communication unit and a wireless communication unit.

The short-range wireless communication unit may include, but is not limited to, a Bluetooth communication unit, a Bluetooth low energy (BLE) communication unit, a near field communication unit, a WLAN (Wi-Fi) communication unit, Zigbee communication unit, an infrared data association (IrDA) communication unit, a Wi-Fi direct (WFD) communication unit, an ultra-wideband (UWB) communication unit, an Ant+communication unit, and the like.

The wireless communication unit may include, but is not limited to, a cellular network communication unit, an Internet communication unit, a computer network (e.g., LAN or WAN) communication unit, and the like.

Although not shown in FIG. 1, the aerosol generating device 1 may further include a connection interface, such as a universal serial bus (USB) interface, and may be connected to another external device through the connection interface, such as the USB interface, to transmit and receive information or charge the power source 11.

The controller 12 may control the overall operation of the aerosol generating device 1. In an embodiment, the controller 12 may include at least one processor. The processor may be implemented as an array of multiple logic gates or as a combination of a general-purpose microprocessor and memory storing a program that can be executed on the microprocessor. In addition, a person skilled in the art may understand that the present disclosure can also be implemented in other forms of hardware.

The controller 12 may control the temperature of the heater 18 by controlling the power of the power source 11 to be supplied to the heater 18. The controller 12 may control the temperature of the cartridge heater 24 and/or the heater 18 based on the temperature of the cartridge heater 24 and/or the heater 18 sensed by the temperature sensor 131. The controller 12 may adjust the power supplied to the cartridge heater 24 and/or the heater 18 based on the temperature of the cartridge heater 24 and/or the heater 18. For example, the controller 12 may determine a target temperature of the cartridge heater 24 and/or the heater 18 based on the temperature profile stored in the memory 17.

The aerosol generating device 1 may include a power supply circuit (not shown) electrically connected to the power source 11 between the power source 11 and the cartridge heater 24 and/or the heater 18. The power supply circuit may be electrically connected to the cartridge heater 24, or the heater 18. The power supply circuit may include at least one switching element. The switching element may be implemented by a bipolar junction transistor (BJT), a field effective transistor (FET), or the like. The controller 12 may control the power supply circuit.

The controller 12 may control the power supply by controlling switching of the switching element of the power supply circuit. The power supply circuit may be an inverter that converts a direct current power source output from the power source 11 into an alternating current power source. For example, the inverter may be configured as a full-bridge circuit or a half-bridge circuit including a plurality of switching elements.

The controller 12 may turn on the switching element so that power is supplied from the power source 11 to the cartridge heater 24 and/or the heater 18. The controller 12 may turn off the switching element so that the supply of power to the cartridge heater 24 and/or the heater 18 is cut off. The controller 12 may adjust the frequency and/or the duty ratio of the current pulse input to the switching element to adjust the current supplied from the power source 11.

The controller 12 may control the voltage output from the power source 11 by controlling switching of the switching element of the power supply circuit. A power conversion circuit may convert the voltage output from the power source 11. For example, the power conversion circuit may include a buck-converter that steps down the voltage output from the power source 11. For example, the power conversion circuit may be implemented by a buck-boost converter, a Zener diode, or the like.

The controller 12 may control an ON/OFF operation of the switching element included in the power conversion circuit to adjust the level of the voltage output from the power conversion circuit. When the on state of the switching element is maintained, the level of the voltage output from the power conversion circuit may correspond to the level of the voltage output from a power source 11. The duty ratio for the ON/OFF operation of the switching element may correspond to a ratio of the voltage output from the power conversion circuit to the voltage output from power source 11. As the duty ratio for the ON/OFF operation of the switching element decreases, the level of the voltage output from the power conversion circuit may decrease. The heater 18 may be heated based on the voltage output from the power conversion circuit.

The controller 12 may control the heater 18 to receive power by using at least one of a pulse width modulation (PWM) method and a proportional-integral-differential (PID) method.

For example, the controller 12 may control a current pulse having a certain frequency and a duty ratio to be supplied to the heater 18 by using the PWM method. The controller 12 may control the power supplied to the heater 18 by adjusting the frequency and the duty ratio of the current pulse.

For example, the controller 12 may determine a target temperature that is the target of control based on the temperature profile. The controller 12 may control the power supplied to the heater 18 by using the PID method that is a feedback control method through a difference value between the temperature of the heater 18 and the target temperature, a value obtained by integrating the difference value over time, and a value obtained by differentiating the difference value over the time.

The controller 12 may prevent the cartridge heater 24 and/or the heater 18 from being overheated. For example, the controller 12 may control, based on the temperature of the cartridge heater 24 and/or the heater 18 exceeding a preset limit temperature, the operation of the power conversion circuit to cut off the supply of power to the cartridge heater 24 and/or the heater 18. For example, the controller 12 may reduce, based on the temperature of the cartridge heater 24 and/or the heater 18 exceeding a preset limit temperature, the amount of power supplied to the cartridge heater 24 and/or the heater 18 by a certain ratio. For example, the controller 12 may determine that the aerosol generating material contained in the cartridge 19 is exhausted based on the temperature of the cartridge heater 24 exceeding the limit temperature and may cut off the power supply to the cartridge heater 24.

The controller 12 may control charging and discharging of the power source 11. The controller 12 may confirm the temperature of the power source 11 based on the output signal of the temperature sensor 131.

When a power line is connected to a battery terminal of the aerosol generating device 1, the controller 12 may confirm whether the temperature of the power source 11 is equal to or higher than a first limit temperature that is a reference for blocking charge of the power source 11. The controller 12 may control, based on a preset charging current, the power source 11 to be charged when the temperature of the power source 11 is less than the first limit temperature. When the temperature of the power source 11 is equal to or higher than the first limit temperature, the controller 12 may cut off charging of the power source 11.

When the power source of the aerosol generating device 1 is in an on state, the controller 12 may confirm whether the temperature of the power source 11 is equal to or higher than a second limit temperature that is a reference for blocking discharge of the power source 11. The controller 12 may control to use the power stored in the power source 11 when the temperature of the power source 11 is less than the second limit temperature. The controller 12 may stop using the power stored in the power source 11 when the temperature of the power source 11 is equal to or higher than the second limit temperature.

The controller 12 may calculate the remaining capacity for the power stored in the power source 11. For example, the controller 12 may calculate the remaining capacity of the power source 11 based on the voltage and/or current sensing value of the power source 11.

The controller 12 may determine whether the stick S is inserted into the insertion space through the insertion sensing sensor 133. The controller 12 may determine that the stick S is inserted based on the output signal of the insertion sensing sensor 133. When it is determined that the stick S is inserted into the insertion space, the controller 12 may control power to be supplied to the heater 18. For example, the controller 12 may control the power supplied to the heater 18 based on the temperature profile stored in the memory 17.

The temperature profile may include a preheating section and a smoking section. The temperature profile may include information about a target temperature to be reached by the heater 18, and the controller 12 may control power supplied to the heater 18 so that the heater 18 follows the target temperature.

On the other hand, when the temperature of the heater 18 is increased to an excessively high temperature in the preheating section, the temperature of the heater 18 may be rapidly increased to a temperature equal to or higher than the temperature at which the aerosol is generated, thereby causing carbonization of the aerosol-generating substrate. It is also possible to provide an excessively hot main smoke in the smoking section.

On the contrary, when the temperature of the heater 18 in the preheating section is increased to an excessively low temperature, the thermal sensation of the main smoke may be reduced, but it may be difficult to secure the vapor, thereby failing to provide a satisfactory smoking sensation to the user. Accordingly, the aerosol generating device 1 of the present disclosure may perform temperature control in the form of “N” in the preheating section. As the aerosol generating device 1 performs temperature control in the form of “N” in the preheating section, the heater may be stably preheated to a target temperature without carbonization of the aerosol generating substrate. Therefore, the aerosol generating device 1 of the present disclosure may provide the user with rich vapor and taste in the smoking section.

Specifically, the controller 12 may control the power supplied to the heater 18 based on a first target temperature, a second target temperature, a third target temperature, and a fourth target temperature in the preheating section. The first target temperature to the fourth target temperature may each have a different value. The controller 12 may control the power supplied to the heater 18 such that the heater 18 is sequentially heated to the first target temperature to the fourth target temperature in the preheating section.

The preheating section may be divided into four sections, including a first section, a second section after the first section, a third section after the second section, and a fourth section after the third section.

The controller 12 controls the power supplied to the heater 18 such that the temperature of the heater 18 reaches the first target temperature from the time point when the heating operation of the heater 18 is initiated in the first section.

The controller 12 controls the power supplied to the heater 18 such that the temperature of the heater 18 reaches the second target temperature from the first time point when the temperature of the heater 18 reaches the first target temperature in the second section.

The controller 12 controls the power supplied to the heater 18 such that the temperature of the heater 18 reaches the third target temperature from the second target temperature in the third section. The third section may include a section where the temperature of the heater is raised from the second target temperature to the third target temperature and a section where the third target temperature is maintained.

The controller 12 controls the power supplied to the heater 18 such that the temperature of the heater 18 reaches the fourth target temperature from the third target temperature in the fourth section. The fourth section may include a section where the temperature of the heater is lowered from the third target temperature to the fourth target temperature and a section where the fourth target temperature is maintained.

A first time point when the heater 18 reaches the first target temperature may be affected by the temperature/humidity of the surrounding environment and may vary depending on the moisture content in the aerosol generating article inserted into the aerosol generating device 1. That is, the length of the first section is not a fixed value but may vary depending on the temperature/humidity of the surrounding environment or the moisture content in the aerosol generating article. Similarly, the length of the second section may vary depending on the temperature/humidity of the surrounding environment or the moisture content in the aerosol generating article.

The first target temperature may be higher than the second target temperature. In addition, the third target temperature may be lower than the first target temperature and higher than the second target temperature. The fourth target temperature may be lower than the third target temperature and higher than the second target temperature. By lowering the temperature of the heater 18 to the second target temperature lower than the first target temperature, it is possible to prevent carbonization of the aerosol-generating substrate and reduce the thermal sensation of the main smoke. Subsequently, by raising the temperature of the heater 18 again to the third target temperature higher than the second target temperature and lower than the first target temperature, it is possible to provide the user with rich vapor and taste in the smoking section.

The controller 12 may cut off the power supplied to the heater 18 such that the temperature of the heater 18 reaches the second target temperature lower than the first target temperature from the first time point when the temperature of the heater 18 reaches the first target temperature. That is, the controller 12 may cut off the power supplied to the heater 18 from the first time point when the temperature of the heater 18 reaches the first target temperature to the second time point when the temperature of the heater 18 reaches the second target temperature.

In addition, the controller 12 may cut off the power supplied to the heater 18 in the fourth section, so that the temperature of the heater 18 reaches the fourth target temperature lower than the third target temperature.

In an embodiment, the controller 12 may set the length of the third section based on the length of the first section. Specifically, the controller 12 may set the length of the third section in “proportion” to the length of the first section. When the length of the first section where the first target temperature is reached is long, the moisture content in the aerosol generating article inserted into the aerosol generating device 1 is large. In this case, by increasing the length of the third section, the controller 12 may alleviate the thermal sensation of the main smoke provided in the smoking section.

In another embodiment, the controller 12 may set the value of the third target temperature, which is a target temperature of the third section, based on the length of the first section. Specifically, the controller 12 may set the value of the third target temperature in “inverse proportion” to the length of the first section. When the moisture content in the aerosol generating article inserted into the aerosol generating device 1 is high, the length of the first section where the first target temperature is reached may be relatively long. In this case, by setting the third target temperature to be low, the controller 12 may alleviate the thermal sensation of the main smoke provided in the smoking section.

In another embodiment, the controller 12 may set the length of the third section based on the length of the second section. Specifically, the controller 12 may set the length of the third section in “inverse proportion” to the length of the second section. When the length of the second section is short, the temperature of the heater 18 may be lowered too quickly from the first target temperature to the second target temperature, resulting in insufficient vapor. In this case, the controller 12 may increase the length of the third section to secure the amount of vapor provided in the smoking section.

In another embodiment, the controller 12 may set the value of the third target temperature based on the length of the second section. Specifically, the controller 12 may set the value of the third target temperature in “inverse proportion” to the length of the second section. When the length of the second section is short, the temperature of the heater 18 may be lowered too quickly from the first target temperature to the second target temperature, resulting in insufficient vapor. In this case, the controller 12 may set the third target temperature to be high to secure the amount of vapor provided in the smoking section.

In an embodiment, the controller 12 may control the power supplied to the heater 18 in the smoking section based on the number of puffs counted through the puff sensor 132.

Specifically, the controller 12 may control the power supplied to the heater 18 such that the temperature of the heater 18 reaches a fifth target temperature from the fourth target temperature, which is a starting temperature of the smoking section, when the counted number of puffs is K in the smoking section, and the temperature of the heater 18 reaches a sixth target temperature from the fifth target temperature when the counted number of puffs is L greater than K.

The temperature control method of the heater 18 in the smoking section may be a continuous ascent control method and a continuous descent control method.

The continuous ascent control method is a method by which the temperature of the heater 18 continuously increases in the smoking section, where the fifth target temperature is higher than the fourth target temperature and the sixth target temperature is greater than the fifth target temperature.

On the contrary, the continuous descent control method is a method by which the temperature of the heater 18 continuously decreases in the smoking section, where the fifth target temperature is lower than the fourth target temperature and the sixth target temperature is lower than the fifth target temperature.

Compared with the continuous descent control method, the continuous ascent control method may provide the user with sufficient nicotine and glycerin transfer amounts until the end of smoking. That is, it is possible to provide the user with a sufficient amount of vapor and taste until the end of smoking. However, since the temperature of the heater 18 is continuously increased until the end of smoking in the continuous ascent control method, there is a risk that the aerosol generating device 1 may become excessively overheated. In particular, the overheating of the aerosol generating device 1 may be problematic with respect to “continuous smoking”. The “continuous smoking” refers to a smoking performed as a new cigarette is inserted immediately after the smoking on the cigarette ends.

Therefore, embodiments of the present disclosure are characterized in that the heater 18 is controlled using the continuously rising control method so that sufficient nicotine and glycerin transfer amounts are provided to the user until the end of smoking, while the target temperature of the heater 18 is lowered when approaching the end of smoking to prevent overheating of the aerosol generating device 1 in relation to “continuous smoking”.

Specifically, when the counted number of puffs is K in the smoking section, the controller 12 controls the power supplied to the heater 18 such that the temperature of the heater 18 reaches the fifth target temperature higher than the fourth target temperature; when the counted number of puffs is L greater than K, the controller 12 controls the power supplied to the heater 18 such that the temperature of the heater 18 reaches the sixth target temperature higher than the fifth target temperature; when the counted number of puffs is M greater than K, the controller 12 controls the power supplied to the heater 18 such that the temperature of the heater 18 reaches a seventh target temperature lower than the fourth target temperature; and when the counted number of puffs is N greater than M, the controller 12 cuts off the power supplied to the heater 18 and terminates the smoking-related operation of the aerosol generating device 1.

K, L, M, and N which are preset values, may be pre-stored in the memory 17. For example, the total number of puffs of the aerosol generating article inserted into the aerosol generating device 1 may be 14, K may be 7, L may be 10, and M may be 13. The aerosol generating device 1 may terminate heating of the heater 18 when the counted number of puffs is 14. When the preset total number of puffs is N, M may have a relationship of “M=N−1”. That is, the controller 12 lowers the target temperature of the heater 18 when the counted number of puffs through the puff sensor 132 is M (i.e., when the smoking end time point is near), which is the number of puffs, immediately before the heating of the heater 18 ends. Specifically, the controller 12 lowers the temperature of the heater 18 to be lower than the target temperature of the heater 18 at the start of the smoking section.

In an embodiment, the controller 12 may control the output unit 14 to output a notice to terminate the aerosol generating device 1 when the counted number of puffs through the puff sensor 132 is M, which is the number of puffs immediately before the heating of the heater 18 ends.

The controller 12 may determine whether the stick S is removed from the insertion space. For example, the controller 12 may determine whether the stick S is removed from the insertion space through the insertion sensing sensor 133. For example, the controller 12 may determine that the stick S is removed from the insertion space when the temperature of the heater 18 is equal to or higher than the limit temperature or when the gradient of the temperature change of the heater 18 may be equal to or greater than a set gradient. When it is determined that the stick S is removed from the insertion space, the controller 12 may cut off the supply of power to the heater 18.

The controller 12 may control the power supply time and/or the power supply amount to the heater 18 according to the state of the stick S sensed by the sensor 13. The controller 12 may confirm, based on a lookup table, a level range in which the level of the signal of the capacitance sensor is included. The controller 12 may determine the moisture content in the stick S according to the confirmed level range.

When the stick S is in an over-humidified state, the controller 12 may control the power supply time to the heater 18, to increase the preheating time of the stick S, compared with the normal state.

The controller 12 may determine whether to reuse the stick S inserted into the insertion space through the reuse sensing sensor 134. For example, the controller 12 may compare the sensing value of the signal of the reuse sensing sensor 134 with a first reference range in which a first color is included and may determine that the stick S is not used when the sensing value is included in the first reference range. For example, the controller 12 may compare the sensing value of the signal of the reuse sensing sensor 134 with a second reference range in which the second color is included and may determine that the stick S is used when the sensing value is included in the second reference range. When it is determined that the stick S is used, the controller 12 may cut off the supply of power to the heater 18.

The controller 12 may determine whether the cartridge 19 is engaged and/or disengaged through the cartridge sensing sensor 135. For example, the controller 12 may determine whether to engage or disengage the cartridge 19 based on the sensing value of the signal of the cartridge sensing sensor 135.

The controller 12 may determine whether the aerosol generating material of the cartridge 19 is exhausted. For example, the controller 12 may apply power to preheat the cartridge heater 24 and/or the heater 18, determine whether the temperature of the cartridge heater 24 exceeds a limit temperature in the preheating section, and determine that the aerosol-generating material of the cartridge 19 is exhausted when the temperature of the cartridge heater 24 exceeds the limit temperature. When it is determined that the aerosol generating material of the cartridge 19 is exhausted, the controller 12 may cut off the supply of power to the cartridge heater 24 and/or the heater 18.

The controller 12 may determine whether the cartridge 19 is available. For example, the controller 12 may determine, based on the data stored in the memory 17, that the cartridge 19 is not available when the current number of puffs is greater than or equal to the maximum number of puffs set in the cartridge 19. For example, the controller 12 may determine that the cartridge 19 is unavailable when the total time for heating the heater 24 is greater than or equal to the preset maximum time or when the total power supplied to the heater 24 is greater than equal to the preset maximum power.

The controller 12 may determine whether the user inhales through the puff sensor 132. For example, the controller 12 may determine whether a puff is generated based on the sensing value of the signal of the puff sensor 132. For example, the controller 12 may determine the intensity of puff based on the sensing value of the signal of the puff sensor 132. When the number of puffs reaches the preset number of puffs or when no puffs are detected for a preset period of time, the controller 12 may cut off the supply of power to the cartridge heater 24 and/or the heater 18.

The controller 12 may determine whether to engage and/or disengage the cap through the cap sensing sensor 136. For example, the controller 12 may determine whether to engage or disengage the cap based on the sensing value of the signal of the cap sensing sensor 136.

The controller 12 may control the output unit 14 based on the result sensed by the sensor 13. For example, when the counted number of puffs through the puff sensor 132 reaches the preset number, the controller 12 may notify the user that the aerosol generating device 1 is about to be terminated by using at least one of the display 141, the haptic unit 142, and the audio output unit 143. For example, the controller 12 may notify the user through the output unit 14 based on the determination that the stick S is not present in the insertion space. For example, the controller 12 may notify the user through the output unit 14 based on the determination that the cartridge 19 and/or the cap is not mounted. For example, the controller 12 may communicate information about the temperature of the cartridge heater 24 and/or the heater 18 with the user through the output unit 14.

The controller 12 may store and update the history of an event that has occurred in the memory 17 based on occurrence of a certain event. The event may include insertion sensing of the stick S, heating initiation of the stick S, sensing of a puff, end of a puff, overheat sensing of the cartridge heater 24 and/or the heater 18, overvoltage application sensing to the cartridge heater 24 and/or the heater 18, heating termination of the stick S, operation of the aerosol generating device 1, such as on/off of a power source, charging initiation of the power source 11, overcharge sensing of the power source 11, charge termination of the power source 11, and the like, which are performed in the aerosol generating device 1. The history for the event may include a date and time when the event occurred, log data corresponding to the event, and the like. For example, when the certain event is insertion sensing of stick S, the log data corresponding to the event may include data on the sensing value of the insertion sensing sensor 133 or the like. For example, when the certain event is overheat sensing of the cartridge heater 24 and/or the heater 18, the log data corresponding to the event may include data on the temperature of the cartridge heater 24 and/or the heater 18, the voltage applied to the cartridge heater 24 and/or the heater 18, the current flowing through the cartridge heater 24 and/or the heater 18, and the like.

The controller 12 may control to form a communication link with an external device, such as a mobile terminal of the user. Upon receiving the data regarding authentication from the external device through the communication link, the controller 12 may release the restriction on the use of at least one function of the aerosol generating device 1. The data regarding authentication may include data indicating completion of user authentication for the user corresponding to the external device. The user may perform user authentication through the external device. The external device may determine whether the user data is valid based on a birthday of the user, a unique number indicating the user, or the like, and receive data about the usage rights of the aerosol generating device 1 from an external server. The external device may transmit, based on the data about the usage rights, data indicating completion of user authentication to the aerosol generating device 1. When the user authentication is completed, the controller 12 may release the restriction on the use of the at least one function of the aerosol generating device 1. For example, the controller 12 may release the restriction on the use of the heating function that supplies power to the heater 18 when the user authentication is completed.

The controller 12 may transmit data on the state of the aerosol generating device 1 to the external device through the communication link formed with the external device. The external device may output, based on the received state data, a remaining capacity, and an operation mode of the power source 11 of the aerosol generating device 1 through a display of the external device.

The external device may transmit a location search request to the aerosol generating device 1, based on the input that initiates the location search of the aerosol generating device 1. When receiving the location search request from the external device, the controller 12 may control, based on the received location search request, at least one of output devices to perform an operation corresponding to the location search. For example, the haptic unit 142 may generate vibrations in response to the location search request. For example, the display 141 may output an object corresponding to the location search and the search completion in response to the location search request.

Upon receiving firmware data from the external device, the controller 12 may control to perform the firmware update. The external device may confirm a current version of firmware of the aerosol generating device 1 and determine whether there is a new version of the firmware. When an input requesting firmware download is received, the external device may receive a new version of firmware data and may transmit the new version of firmware data to the aerosol generating device 1. The controller 12 may control the firmware update of the aerosol generating device 1 to be performed upon receiving the new version of firmware data.

The controller 12 may transmit data about the sensing value of at least one sensor 13 to the external server (not shown) through the communication unit 16 and may receive and store a learning model generated by learning the sensing value from the server through machine learning, such as deep learning. The controller 12 may use the learning model received from the server to perform an operation of determining the inhalation pattern of the user, an operation of generating the temperature profile, and the like. The controller 12 may store, in the memory 17, sensing value data of the at least one sensor 13 and data for learning an artificial neural network (ANN). For example, the memory 17 may store a database for each configuration provided in the aerosol generating device 1 and weights and biases forming the ANN structure, for learning the ANN. The controller 12 may learn the data about the sensing value of the at least one sensor 13, the inhalation pattern of the user, the temperature profile, and the like stored in the memory 17 to generate at least one learning model used for determining the inhalation pattern of the user, generating the temperature profile, and the like.

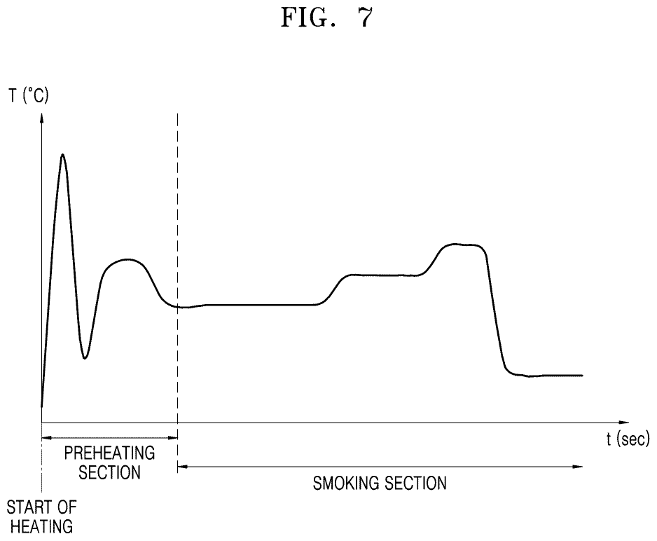

FIG. 7 is a diagram illustrating a temperature profile of an aerosol generating device according to an embodiment.

Referring to FIG. 7, information about the temperature of the heater is shown in FIG. 7. In FIG. 7, the x-axis represents time and the y-axis represents temperature. When the aerosol generating device operates by induction heating, the temperature of the heater may refer to the temperature of the susceptor.

The aerosol generating device may control the power supplied from the power source to the heater such that the temperature of the heater is controlled based on the temperature profile. The aerosol generating device may further include the insertion sensing sensor for sensing insertion and/or removal of the aerosol generating article. When the insertion of the aerosol generating article is sensed by the insertion sensing sensor, the controller may initiate the heating operation of the heater according to the temperature profile. In other words, the aerosol generating device may initiate the heating operation of the heater based on insertion sensing of the aerosol generating article, even without a separate user input. However, the present disclosure is not necessarily limited thereto. The aerosol generating device may further include a user interface, such as a button, and may initiate the heating operation of the heater based on an input received through the user interface.

The aerosol generating device may preheat the aerosol generating article before the user's smoking involving the user puff is performed. The preheating section may correspond to a section of preparation for use before performing the smoking using the aerosol generating device. Thus, a sufficient amount of aerosol may be delivered from the first puff of the user. The aerosol generating device may perform the preheating operation of the heater according to the preheating profile and may notify that the preheating is completed when the preheating profile ends. When the preheating profile ends, the aerosol generating device may perform the heating operation of the heater according to the smoking profile. The smoking section may correspond to a section where the smoking using the aerosol generating device is actually performed. The user may be notified by the notification that the user is ready to smoke and may perform smoking, accompanied by the user puff, during the smoking section.

The temperature profile may include information about the target temperature and the heating time. The temperature profile may be divided into the preheating section and the smoking section based on the target temperature and/or the heating time. The preheating section may refer to a section for increasing the temperature of the heater to a preset target temperature. The smoking section may refer to a section where an actual puff is performed and the temperature of the heater is maintained within a preset target temperature range.

When the controller controls the power supplied to the heater based on one target temperature and the preheating time is short, the temperature of the heater may increase rapidly in a short period of time and the rapid increase in the temperature of the heater may cause carbonization of the aerosol-generating substrate. In addition, when the controller controls the power supplied to the heater based on one target temperature and the preheating time is long, the preheating time may excessively increase, thereby increasing user dissatisfaction. When only a section where the temperature increases is included in the preheating section, the aerosol transfer may not be maintained at the beginning of smoking due to the excessively large amount of aerosol transfer at the end of smoking.

To solve this problem, the aerosol generating device of the present disclosure may perform multi-stage temperature control in the preheating section. Hereinafter, the preheating profile of the aerosol generating device according to the present disclosure is described in detail with reference to the drawings. The aerosol generating device according to an embodiment may maintain the amount of aerosol transfer throughout the smoking process.

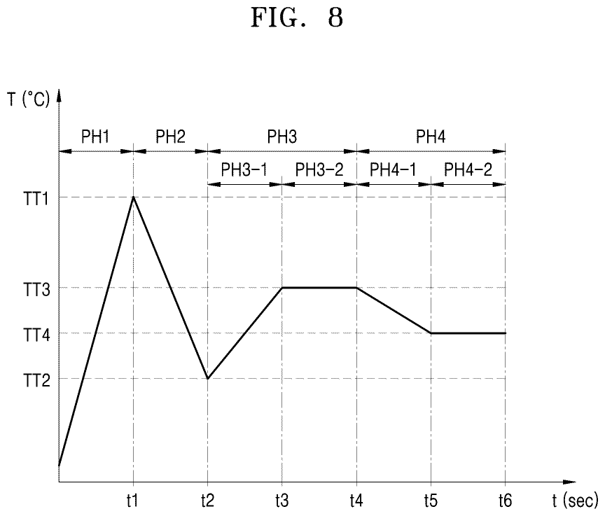

In FIGS. 8 to 10 described below, the graph of the temperature change of the heater over time is composed of straight lines. However, this is only for convenience of description, and as shown in FIG. 7, the actual temperature graph of the heater may include at least one curve.

FIG. 8 is a diagram illustrating a temperature profile in a preheating section according to an embodiment of the present disclosure.

The preheating section may be divided into four sections.

A first target temperature TT1 may be higher than a second target temperature TT2. In addition, a third target temperature TT3 may be lower than the first target temperature TT1 and higher than the second target temperature TT2. A fourth target temperature TT4 may be lower than the third target temperature TT3 and higher than the second target temperature TT2. The temperature profile of the heater in the preheating section may have the form of “N”. As described above, by lowering the temperature of the heater in the preheating section to the second target temperature TT2 lower than the first target temperature TT1, it is possible to prevent carbonization of the aerosol-generating substrate and reduce the thermal sensation of the main smoke. Subsequently, by raising the temperature of the heater again to the third target temperature TT3 higher than the second target temperature TT2 and lower than the first target temperature TT1, it is possible to provide the user with rich vapor and taste in the smoking section.

A first section PH1 includes a section from the start of heating to a first time point t1 at which the temperature of the heater reaches the first target temperature TT1. The first time point t1 at which the heater reaches the first target temperature TT1 may be affected by the temperature/humidity of the surrounding environment and may vary depending on the moisture content in the aerosol generating article inserted into the aerosol generating device. The controller may control the power supplied to the heater such that the temperature of the heater reaches the first target temperature TT1. Therefore, a first time, which is the length of the first section PH1, is not a fixed value but may vary depending on the temperature/humidity of the surrounding environment or the moisture content in the aerosol generating article.

A second section PH2 includes a section from the first time point t1 to a second time point t2 at which the temperature of the heater reaches the second target temperature TT2. A second time point t2 at which the heater reaches the second target temperature TT2 may also depend on the temperature/humidity of the surrounding environment or the moisture content in the aerosol generating article. Therefore, a second time, which is the length of the second section PH2, is not a fixed value but may vary depending on the temperature/humidity of the surrounding environment or the moisture content in the aerosol generating article. The controller may control the power supplied to the heater in the second section PH2 to be cut off.

A third section PH3 has the length of a third time and is a section from the second time point t2 to a fourth time point t4. The controller may control the power supplied to the heater such that the temperature of the heater in the third section PH3 follows the third target temperature TT3. The length of the third section PH3 may vary, and the controller may set the length of the third section PH3 based on the length of the first section PH1 or the length of the second section PH2. The value of the third target temperature TT3 may vary, and the controller may set the value of the third target temperature TT3 based on the length of the first section PH1. The heater may reach the third target temperature TT3 before reaching the fourth time point t4, in which case the heater may include a maintaining section where the third target temperature is maintained. That is, the third section PH3 may be divided into a third-1 section PH3-1 where the temperature of the heater increases from the second target temperature TT2 to the third target temperature TT3 and a third-2 section PH3-2 where the temperature thereof is maintained at the third target temperature TT3.

In an embodiment, the controller may set the length of the third time in proportion to the first time that is the length of the first section PH1. In addition, the controller may set the value of the third target temperature TT3 in inverse proportion to the first time.

In another embodiment, the controller may set the length of the third time in inverse proportion to the second time that is the length of the second section PH2. In addition, the controller may set the value of the third target temperature TT3 in inverse proportion to the second time.

The fourth section PH4 has the length of the fourth time and is a section from the fourth time point t4 to a sixth time point t6. The controller may control the power supplied to the heater such that the temperature of the heater in the fourth section PH4 follows the fourth target temperature TT4. The heater may reach the fourth target temperature TT4 before reaching the sixth time point t6, in which case the heater may include a maintaining section where the fourth target temperature TT4 is maintained. That is, the fourth section PH4 may be divided into a fourth-1 section PH4-1 where the temperature of the heater is lowered from the third target temperature TT3 to the fourth target temperature TT4 and a fourth-2 section PH4-2 where the temperature of the heater is maintained at the fourth target temperature TT4. The length of the entire preheating section may have a fixed value, and as the length of the first section PH1 to the third section PH3 varies, the length of the fourth section PH4 may also vary. The controller may control the power supplied to the heater in the fourth-1 section PH4-1 to be cut off.

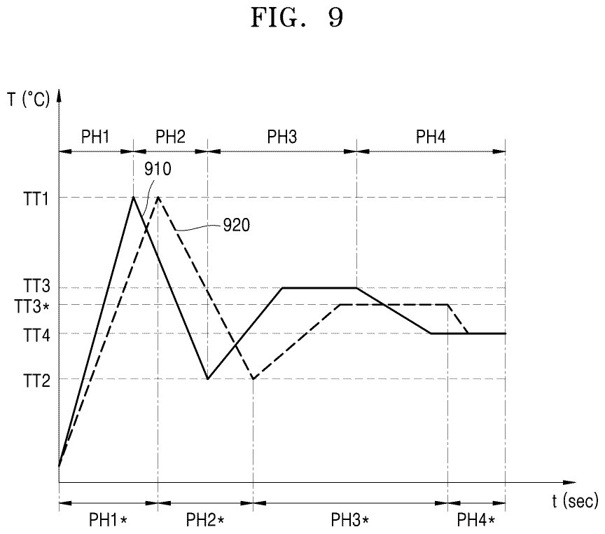

FIG. 9 is a diagram illustrating a method of adjusting the temperature profile in the preheating section by the aerosol generating device according to an embodiment of the present disclosure.

Referring to FIG. 9, a first temperature profile 910 in a case where the aerosol generating article in a normal state is inserted into the aerosol generating device and a second temperature profile 920 in a case where the aerosol generating article in an over-humidified state is inserted into the aerosol generating device are illustrated. When the aerosol generating article is in the over-humidified state, it indicates a case where the moisture content in the aerosol generating article exceeds a reference value and the moisture content is higher than that of the aerosol generating article in the normal state.

The first temperature profile 910 may be the same as the temperature profile described with reference to FIG. 8.

In the first section, the length of a first section PH1* of the second temperature profile 920 may be greater than the length of the first section PH1 of the first temperature profile 910. The second temperature profile 920 is a case where the aerosol generating article is in an over-humidified state, and the specific heat is relatively increased, compared to the aerosol generating article in a normal state, due to the high moisture content of the aerosol generating article. Therefore, although the power supplied to the heater is the same, the first target temperature TT1 is reached later when the aerosol generating article is in the over-humidified state than when the aerosol generating article is in the normal state.

In the second section, the length of a second section PH2* of the second temperature profile 920 may be greater than the length of the second section PH2 of the first temperature profile 910.

The length of the third section may be set in “proportion” to the length of the first section. It may be seen that the length of the first section PH1 of the first temperature profile 910 is set to be shorter than the length of the first section PH1* of the second temperature profile 920 and the length of the third section PH3 of the first temperature profiles 910 is set to be shorter than the length of a third section PH3* of the second temperature profile 920. When the length of the first section is long, it may be a case where the aerosol generating article is in an over-humidified state. In this case, by increasing the length of the third section, it is possible to alleviate the thermal sensation of the main smoke provided in the smoking section.

In addition, in the third section, the third target temperature TT3 may be set in “inverse proportion” to the length of the first section. It may be seen that the length of the first section PH1 of the first temperature profile 910 is shorter than the length of the first section PH1* of the second temperature profile 920 and the third target temperature TT3 of the first temperature profile 910 is set to be higher than the third target temperature TT3* of the second temperature profile 920. When the length of the first section is long, the aerosol generating article may be in an over-humidified state, and in this case, by setting the third target temperature to be low, it is possible to alleviate the thermal sensation of the main smoke provided in the smoking section.

In addition, the length of the third section may be set to be in “inverse proportion” to the length of the second section. When the length of the second section is short, the temperature of the heater may be lowered too quickly from the first target temperature to the second target temperature, resulting in an insufficient amount of vapor. In this case, it is preferable to increase the length of the third section to secure the amount of vapor provided in the smoking section.

In addition, the third target temperature in the third section may be set to be in “inverse proportion” to the length of the second section. It may be seen that the length of the second section PH2 of the first temperature profile 910 is shorter than the length of the second section PH2* of the second temperature profile 920 and the third target temperature TT3 of the first temperature profile 910 is set to be higher than the third target temperature TT3* of the second temperature profile 920. When the length of the second section is short, the amount of vapor may be insufficient. When the length of the second section is short, the amount of vapor may be insufficient. In this case, by setting the third target temperature to be high, it is preferable to secure the amount of vapor provided in the smoking section.

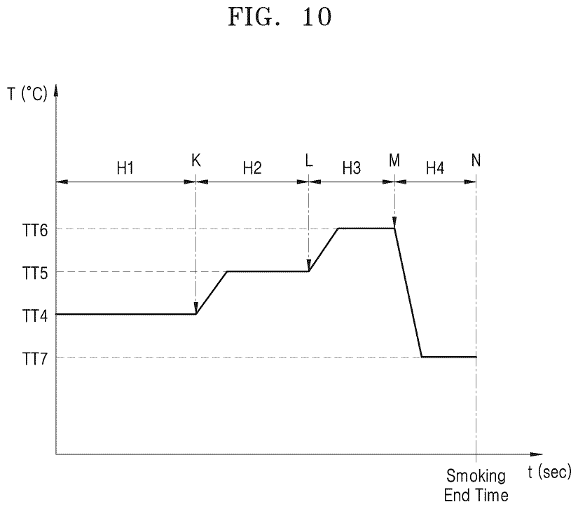

FIG. 10 is a diagram illustrating a temperature profile in a smoking section according to an embodiment of the present disclosure.

The controller may control the power supplied to the heater based on the number of puffs counted through the puff sensor in the smoking section. In one example, the smoking section may be divided into four sections. For example, the smoking section may be divided based on the number of puffs having reached K, L, M, and N.

In an embodiment, the controller may set the values of K, L, M, and N based on the type of the aerosol generating article inserted into the aerosol generating device. The aerosol generating device may further include a button for receiving the user input or a sensor for identifying the type of aerosol generating article. The user input received by the button may correspond to a mode selection or a type selection of the aerosol generating article. In the aerosol generating device, the values of K, L, M, and N of the user input may be preset and prestored in the memory. The values of K, L, M, and N may be stored in the memory in the form of a look-up table matching the type of aerosol generating article.

A fifth target temperature TT5 may be higher than the fourth target temperature TT4. In addition, a sixth target temperature TT6 may be higher than the fifth target temperature TT5. The seventh target temperature TT7 may be lower than the fourth target temperature TT4.

The first section H1 is a section where the counted number of puffs is K from the start of the smoking section. The controller may control the power supplied to the heater such that the temperature of the heater follows the fourth target temperature TT4 in the first section H1.

The second section H2 is a section where the counted number of puffs is L after the number of puffs is K. The controller may control the power supplied to the heater such that the temperature of the heater follows the fifth target temperature TT5 in the second section H2.

The third section H3 is a section where the counted number of puffs is M after the number of puffs is L. The controller may control the power supplied to the heater such that the temperature of the heater follows the sixth target temperature TT6 in the third section H3.

The fourth section H4 is a section from when the number of puffs is M to the end of smoking. When the number of puffs counted through the puff sensor reaches the preset number of N, the controller may cut off power supplied to the heater to end heating of the heater. The controller may control the power supplied to the heater such that the temperature of the heater follows a seventh target temperature TT7 in the fourth section H4. In an embodiment, “N=M+a”. a may have a value of 1 or greater. When a has a value of 1, the controller may control the power supplied to the heater such that the temperature of the heater follows the seventh target temperature TT7 when the number of puffs before the preset number of N is counted.

Compared with the continuous descent control method, the continuous ascent control method may provide the user with sufficient nicotine and glycerin transfer amounts until the end of smoking. That is, it is possible to provide the user with a sufficient amount of vapor and taste until the end of smoking. However, since the temperature of the heater is continuously increased until the end of smoking in the continuous ascent control method, there is a risk of the aerosol generating device becoming excessively overheated. In particular, the overheating of the aerosol generating device may cause problems with “continuous smoking”. The “continuous smoking” refers to a smoking performed as a new cigarette is inserted immediately after the smoking on the cigarette has ended.

Therefore, the embodiments of the present disclosure are characterized in that the heating operation of the heater is controlled using the continuous ascent control method so that sufficient nicotine and glycerin transfer amounts are provided to the user until the end of smoking, and the target temperature of the heater is lowered when approaching the end of smoking (when the counted number of puffs is M) to prevent overheating of the aerosol generating device in relation to “continuous smoking”.

An embodiment may also be implemented in the form of a recording medium that includes computer-executable instructions, such as program modules executed by a computer. Computer-readable media may be any available media that can be accessed by a computer and may include both volatile and nonvolatile media and removable and non-removable media. In addition, the computer-readable media may include both computer storage media and communication media. The computer storage media include both volatile and nonvolatile media and removable and non-removable media implemented by any method or technology for storage of information, such as computer-readable instructions, data structures, program modules, or other data. The communication media typically include computer-readable instructions, data structures, or other data in modulated data signals, such as program modules, or other transport mechanisms, and include any information delivery media.

The foregoing description of embodiments is merely illustrative, and a person skilled in the art may understand that various modifications and equivalent alternative embodiments are possible therefrom. Therefore, the true scope of protection of the disclosure should be defined by the appended claims, and all differences within the scope equivalent to the contents described in the claims should be interpreted as being included in the scope of protection defined by the claims.

1. An aerosol generating device, comprising:
a power source;
a heater that heats an aerosol generating article based on power supplied from the power source;
a temperature sensor that senses a temperature of the heater; and
a controller that controls the power supplied to the heater based on a temperature profile including a preheating section and a smoking section, wherein the controller controls the power supplied to the heater in the preheating section based on:
a first target temperature;
a second target temperature lower than the first target temperature;
a third target temperature lower than the first target temperature and higher than the second target temperature; and
a fourth target temperature lower than the third target temperature and higher than the second target temperature.

2. The aerosol generating device of claim 1, wherein the preheating section comprises a first section, a second section after the first section, a third section after the second section, and a fourth section after the third section, and the controller controls the power supplied to the heater in the first section such that the temperature of the heater reaches the first target temperature from a time point when a heating operation of the heater is initiated, controls the power supplied to the heater in the second section such that the temperature of the heater reaches the second target temperature from a first time point when the temperature of the heater reaches the first target temperature, controls the power supplied to the heater in the third section such that the temperature of the heater reaches the third target temperature from a second time point when the temperature of the heater reaches the second target temperature, and controls the power supplied to the heater in the fourth section such that the temperature of the heater reaches the fourth target temperature.

3. The aerosol generating device of claim 2, wherein the third section comprises a third-1 section and a third-2 section following the third-1 section, and the controller controls the power supplied to the heater in the third-1 section such that the temperature of the heater reaches the third target temperature from a second time point when the temperature of the heater reaches the second target temperature, and controls the power supplied to the heater in the third-2 section such that the temperature of the heater is maintained at the third target temperature.

4. The aerosol generating device of claim 2, wherein the fourth section comprises a fourth-1 section and a fourth-2 section following the fourth-1 section, and
the controller controls the power supplied to the heater in the fourth-1 section such that the temperature of the heater reaches the fourth target temperature from the third target temperature, and controls the power supplied to the heater in the fourth-2 section such that the temperature of the heater is maintained at the fourth target temperature.

5. The aerosol generating device of claim 2, wherein the controller cuts off the power supplied to the heater from the first time point to the second time point.

6. The aerosol generating device of claim 2, wherein the controller sets a length of the third section based on a length of the first section.

7. The aerosol generating device of claim 2, wherein the controller sets a length of the third section based on a length of the second section.

8. The aerosol generating device of claim 2, wherein the controller sets a value of the third target temperature based on a length of the first section.

9. The aerosol generating device of claim 6, wherein the controller sets the length of the third section in proportion to the length of the first section.

10. The aerosol generating device of claim 8, wherein the controller sets a value of the third target temperature in inverse proportion to the length of the first section.

11. The aerosol generating device of claim 1, further comprising a puff sensor that senses a puff of a user and outputs a signal corresponding to the puff, wherein the controller controls, based on a number of puffs counted through the puff sensor, the power supplied to the heater in the smoking section.

12. The aerosol generating device of claim 11, wherein the controller controls the power supplied to the heater such that the temperature of the heater reaches a fifth target temperature higher than the fourth target temperature when the counted number of puffs is K, controls the power supplied to the heater such that the temperature of the heater reaches a sixth target temperature higher than the fifth target temperature when the counted number of puffs is L greater than K, and controls the power supplied to the heater such that the temperature of the heater reaches a seventh target temperature lower than the fourth target temperature when the counted number of puffs is M greater than K.

13. The aerosol generating device of claim 12, further comprising an output unit that outputs information on a state of the aerosol generating device, wherein the controller controls the output unit such that the output unit outputs a notice to terminate an operation of the aerosol generating device when the counted number of puffs is M.

14. The aerosol generating device of claim 13, wherein, when the counted number of puffs is M+1, the controller controls the power supplied to the heater to be cut off, and controls the output unit such that the output unit outputs the notice to terminate the operation of the aerosol generating device.

15. The aerosol generating device of claim 13, wherein the output unit communicates information about a state of the aerosol generating device to a user using at least one of tactile, visual, or auditory means.
